(19) United States
(12) Patent Application Publication
(10) Pub. No.: US 2025/0080680 A1
(43) Pub. Date: Mar. 6, 2025

(54) IMAGE READING APPARATUS, IMAGE READING METHOD, AND NON-TRANSITORY RECORDING MEDIUM

(71) Applicant: PFU LIMITED, Kahoku-shi, ISHIKAWA (JP)

(72) Inventor: Kengo Nakano, Kahoku-shi (JP)

(21) Appl. No.: 18/813,479

(22) Filed: Aug. 23, 2024

(30) Foreign Application Priority Data
Aug. 28, 2023 (JP) 2023-138315

(51) Int. Cl. H04N 1/409; H04N 1/00

(52) U.S. Cl. CPC H04N 1/409; H04N 1/00822

(57) ABSTRACT

An image reading apparatus includes an image reader that includes a line sensor to read a reading object line by line, and circuitry. The image reader reads the reading object at a first resolution and generates image data having the first resolution, and circuitry converts the image data having the first resolution into image data having a second resolution lower than the first resolution and outputs the image data having the second resolution. An exposure time per line is shorter when the reading object is read at the first resolution than when the reading object is read at the second resolution.

### CROSS-REFERENCE TO RELATED APPLICATIONS

This patent application is based on and claims priority pursuant to 35 U.S.C. § 119 (a) to Japanese Patent Application No. 2023-138315, filed on Aug. 28, 2023, in the Japan Patent Office, the entire disclosure of which is hereby incorporated by reference herein.

### BACKGROUND

The present disclosure relates to an image reading apparatus, an image reading method, and a non-transitory recording medium.

For image reading apparatuses such as scanners that read an object to be read and generate image data, it is desired to increase the quality of the image data. Moire (a rippled interference pattern) may occur in image data generated by an image reading apparatus.

There are color image reading apparatuses that read an image by sequentially turning on respective light sources of multiple colors with respect to a scan line. The color image reading apparatus sets the lighting frequency ratio of the light sources such that not all of the light sources of multiple colors are equally lighted, performs thinning control of lighting lines according to the lighting frequency ratio of the light sources, and combines read data of multiple colors obtained under the thinning control in a predetermined combination.

### SUMMARY

In one aspect, an image reading apparatus includes an image reader that includes a line sensor to read a reading object line by line, and circuitry. The image reader reads the reading object at a first resolution and generates image data having the first resolution, and circuitry converts the image data having the first resolution into image data having a second resolution lower than the first resolution and outputs the image data having the second resolution. An exposure time per line is shorter when the reading object is read at the first resolution than when the reading object is read at the second resolution.

In another aspect, an image reading method includes reading a reading object at a first resolution line by line with an image reader including a line sensor to generate image data having the first resolution, converting the image data having the first resolution into image data having a second resolution lower than the first resolution, and outputting the image data having the second resolution. In the reading, an exposure time per line is shorter when the reading object is read at the first resolution than when the reading object is read at the second resolution.

In another aspect, a non-transitory recording medium stores a plurality of program codes which, when executed by one or more processors, causes the processors to perform a method for controlling a media conveying apparatus. The method includes reading a reading object at a first resolution line by line with an image reader including a line sensor to generate image data having the first resolution, converting the image data having the first resolution into image data having a second resolution lower than the first resolution, and outputting the image data having the second resolution. In the reading, an exposure time per line is shorter when the reading object is read at the first resolution than when the reading object is read at the second resolution.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image reading apparatus according one embodiment;

FIG. 2 is a diagram illustrating a conveyance passage inside the image reading apparatus according to one embodiment;

FIG. 3 is a schematic diagram illustrating an imaging device according to one embodiment;

FIG. 4 is a schematic block diagram illustrating a configuration of the image reading apparatus according to one embodiment;

FIG. 5 is a schematic diagram illustrating a configuration of a storage device and a processing circuit according to one embodiment;

FIG. 6 is a table presenting an example of a data structure of a setting table;

FIG. 7 is a schematic diagram illustrating the color of irradiation light on a medium;

FIG. 8 is a schematic chart illustrating an example of a control signal;

FIG. 9 is a flowchart illustrating example operations in a media reading process;

FIGS. 10A and 10B are diagrams each illustrating a configuration of an image reading apparatus according to another embodiment;

FIG. 11 is a cross-sectional view of the image reading apparatus illustrated in FIGS. 10A and 10B;

FIG. 12 is a flowchart illustrating example operations in a media reading process; and

FIG. 13 is a schematic block diagram illustrating a configuration of a processing circuit of an image reading apparatus according to yet another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an image reading apparatus, an image reading method, and a control program according to embodiments of the present disclosure are described below. As used herein, the singular forms “a,” “an,” and “the” are intended to include the plural forms as well, unless the context clearly indicates otherwise.

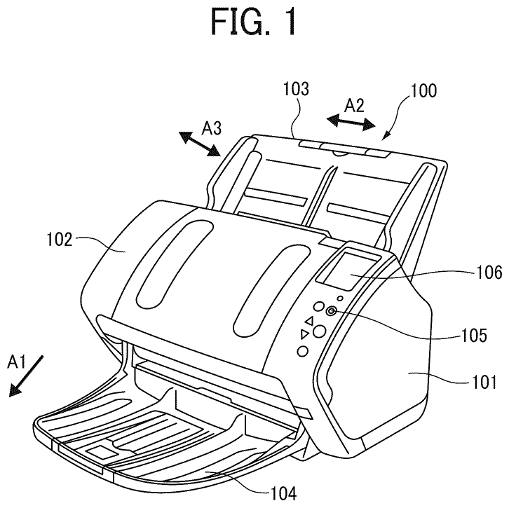

FIG. 1 is a perspective view of the image reading apparatus, which is an image scanner, according to one embodiment. An image reading apparatus 100 illustrated in FIG. 1 conveys media that are documents and images the media. A medium is an example of the object to be read (may be also “reading object”) and is a sheet of plain paper, a sheet of thick paper, a card, etc. The image reading apparatus 100 may be a facsimile machine, a copier, or a multifunction peripheral (MFP). An MFP may be also called a multifunction printer.

The image reading apparatus 100 includes a lower housing 101, an upper housing 102, a media tray 103, an ejection tray 104, an operation device 105, and a display device 106.

The upper housing 102 is located to cover the upper face of the image reading apparatus 100, and is hinged to the lower housing 101 such that the upper housing 102 can be opened and closed, for example, to remove a jammed medium or clean the inside of the image reading apparatus 100.

The media tray 103 is engaged with the lower housing 101 such that the media to be conveyed can be placed on the media tray 103. The ejection tray 104 is engaged with the upper housing 102 such that the ejected media can be held on the ejection tray 104. The ejection tray 104 may be engaged with the lower housing 101.

The operation device 105 includes an input device such as buttons and an interface circuit that receives signals from the input device. The operation device 105 receives an input operation performed by a user and outputs an operation signal corresponding to the input operation performed by the user. The display device 106 includes a display and an interface circuit that outputs image data to the display and displays the image data on the display. Examples of the display include a liquid crystal display and an organic electro-luminescence (EL) display.

In FIG. 1, arrow A1 indicates the direction in which a medium is conveyed (also “media conveyance direction A1”), arrow A2 indicates the width direction perpendicular to the media conveyance direction (also “width direction A2”), and arrow A3 indicates the height direction perpendicular to the media conveyance direction and the width direction (also “height direction A3”). In the following, upstream is upstream in the media conveyance direction A1, and downstream is downstream in the media conveyance direction A1.

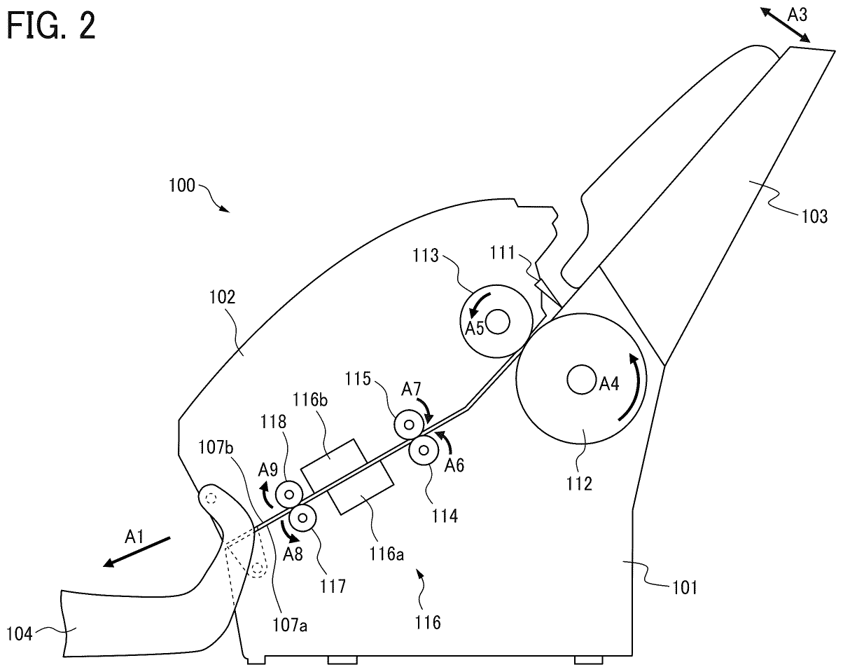

FIG. 2 is a diagram illustrating a conveyance passage inside the image reading apparatus according to one embodiment.

The image reading apparatus 100 includes a media sensor 111, a feed roller 112, a separation roller 113, a first conveyance roller 114, a second conveyance roller 115, an imaging device 116, a third conveyance roller 117, and a fourth conveyance roller 118 along the media conveyance passage. The feed roller 112, the separation roller 113, the first conveyance roller 114, the second conveyance roller 115, the third conveyance roller 117, and the fourth conveyance roller 118 are examples of a conveyor to convey media. The number of each roller is not limited to one, but may be two or more. When one or more of the above rollers are formed of multiple rollers, the multiple rollers are arranged at intervals in the width direction A2.

The image reading apparatus 100 has a so-called straight path. The upper face of the lower housing 101 forms a lower guide 107a for the conveyance passage of media (also called a “media conveyance passage” in the following description), and the lower face of the upper housing 102 forms an upper guide 107b for the media conveyance passage. The lower guide 107a is an example of a guide that guides media.

The media sensor 111 is located upstream from the feed roller 112 and the separation roller 113. The media sensor 111 includes a contact detection sensor and detects whether a medium is placed on the media tray 103. The media sensor 111 generates and outputs a first media signal whose signal value changes depending on whether a medium is placed on the media tray 103. The media sensor 111 is not limited to a contact detection sensor but may be any sensor such as an optical detection sensor that can detect the presence of a medium.

The feed roller 112 is in the lower housing 101 and sequentially feeds the media placed on the media tray 103 from the bottom. The separation roller 113 is a so-called brake roller or retard roller located at the upper housing 102 to face the feed roller 112. The feed roller 112 and the separation roller 113 function as a separator that separates the media.

The first conveyance roller 114 and the second conveyance roller 115 are located downstream from the feed roller 112 and the separation roller 113 to face each other. The first conveyance roller 114 and the second conveyance roller 115 convey the media fed by the feed roller 112 and the separation roller 113 to the imaging device 116.

The third conveyance roller 117 and the fourth conveyance roller 118, which are located downstream from the imaging device 116 to face each other, eject the medium conveyed by the first conveyance roller 114 and the second conveyance roller 115 onto the ejection tray 104.

The media placed on the media tray 103 are conveyed between the lower guide 107a and the upper guide 107b in the media conveyance direction A1 as the feed roller 112 rotates in the direction indicated by arrow A4 (also “media feeding direction A4”) in FIG. 2. The separation roller 113 rotates or stops in the direction indicated by arrow A5 in FIG. 2 when conveying the media. When multiple media are placed on the media tray 103, only the medium in contact with the feed roller 112 is separated from the rest of the media on the media tray 103 due to the action of the feed roller 112 and separation roller 113. This operation prevents the feeding of a medium other than the separated medium (prevention of multi-feed).

The medium is fed between the first conveyance roller 114 and the second conveyance roller 115 while being guided by the lower guide 107a and the upper guide 107b. The medium is fed between the first imaging device 116a and the second imaging device 116b as the first conveyance roller 114 and the second conveyance roller 115 rotate in the directions indicated by arrows A6 and A7 in FIG. 2, respectively. The medium read by the imaging device 116 is ejected onto the ejection tray 104 as the third conveyance roller 117 and the fourth conveyance roller 118 rotate in the directions indicated by arrows A8 and A9 in FIG. 2, respectively.

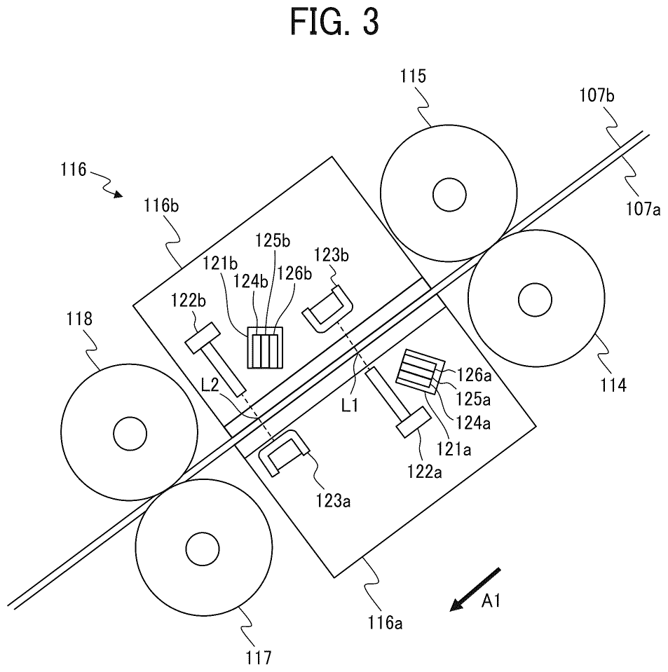

FIG. 3 is a schematic diagram illustrating the imaging device according to one embodiment.

The imaging device 116 is an example of an image reader and reads a medium to generate read image data. The read image data is an example of image data generated by the image reader. As illustrated in FIG. 2, the imaging device 116 is located downstream from the first conveyance roller 114 and the second conveyance roller 115 and upstream from the third conveyance roller 117 and the fourth conveyance roller 118. The imaging device 116 includes a first imaging device 116a and a second imaging device 116b. The first imaging device 116a and the second imaging device 116b are located near the media conveyance passage to face each other across the media conveyance passage.

As illustrated in FIG. 3, the first imaging device 116a includes a first light-emitting device 121a, a first line sensor 122a, a first backing member 123a, etc. The second imaging device 116b includes a second light-emitting device 121b, a second line sensor 122b, a second backing member 123b, etc.

The first light-emitting device 121a is located to face the second backing member 123b across the media conveyance passage. The first light-emitting device 121a is a light source that irradiates a medium being conveyed with light and includes a first red light-emitting device 124a, a first green light-emitting device 125a, and a first blue light-emitting device 126a. The first red light-emitting device 124a, the first green light-emitting device 125a, and the first blue light-emitting device 126a irradiate the medium being conveyed with red light, green light, and blue light, respectively. The first light-emitting device 121a emits light toward the front side of the medium conveyed to the position of the imaging device 116.

Similarly, the second light-emitting device 121b is located to face the first backing member 123a across the media conveyance passage. The second light-emitting device 121b is a light source that irradiates the medium being conveyed with light and includes a second red light-emitting device 124b, a second green light-emitting device 125b, and a second blue light-emitting device 126b. The second red light-emitting device 124b, the second green light-emitting device 125b, and the second blue light-emitting device 126b irradiate the medium being conveyed with red light, green light, and blue light, respectively. The second light-emitting device 121b emits light toward the back side of the medium conveyed to the position of the imaging device 116.

The first line sensor 122a is located to face the second backing member 123b across the media conveyance passage. The first line sensor 122a includes a unity-magnification contact image sensor (CIS). The CIS includes complementary metal oxide semiconductor (CMOS) imaging elements linearly arranged in the main scanning direction. Each imaging element outputs an electric signal having a signal value corresponding to red, green, and blue (RGB). The first line sensor 122a preferably includes an output port having six or more channels to ensure processing performance. The first imaging device 116a further includes a lens that forms an image on the imaging elements and an analog-to-digital (A/D) converter. The A/D converter amplifies the electrical signals output from the imaging elements and performs analog-to-digital (A/D) conversion. The first line sensor 122a reads the front side of the conveyed medium line by line at an imaging position L1 and generate read image data.

Similarly, the second line sensor 122b is located to face the first backing member 123a across the media conveyance passage. The second line sensor 122b includes a line sensor based on a unity-magnification CIS including CMOS imaging elements arranged linearly in the main scanning direction. Each imaging element outputs an electric signal having a signal value corresponding red, green, and blue (RGB). The second line sensor 122b preferably includes an output port having six or more channels to ensure the processing performance. The second imaging device 116b further includes a lens that forms an image on the imaging elements and an A/D converter. The A/D converter amplifies the electrical signals output from the imaging elements and performs A/D conversion. The second line sensor 122b reads the back side of the conveyed medium line by line at an imaging position L2 and generates read image data.

The first line sensor 122a and the second line sensor 122b are single-line monochrome sensors and identify the values of the RGB color components of the reading object while switching the colors of light emitted by the first light-emitting device 121a and the second light-emitting device 121b. The single-line monochrome sensor is inexpensive compared with a three-line color sensor having three line sensors corresponding to RGB colors. Therefore, the use of the single-line monochrome sensors as the first line sensor 122a and the second line sensor 122b can reduce the cost of the image reading apparatus 100.

Instead of the line sensor based on a unity-magnification CIS including CMOS imaging elements, a line sensor based on a unity-magnification CIS including charge-coupled device (CCD) imaging elements may be used. Alternatively, a line sensor employing a reduction optical system and including CMOS or CCD imaging elements may be used. Further, either one of the set of the first light-emitting device 121a, the first line sensor 122a, and the second backing member 123b or the set of the second light-emitting device 121b, the second line sensor 122b, and the first backing member 123a may be omitted.

The first backing member 123a is at a position facing to the second light-emitting device 121b and the second line sensor 122b. The side of the first backing member 123a facing the second line sensor 122b is, for example, white. The first backing member 123a functions as a white reference for image correction such as shading based on an image signal obtained by imaging the first backing member 123a.

Similarly, the second backing member 123b is at a position facing to the first light-emitting device 121a and the first line sensor 122a. The side of the second backing member 123b facing the first line sensor 122a is, for example, white. The second backing member 123b functions as a white reference for image correction such as shading based on an image signal obtained by imaging the second backing member 123b.

In the following description, the first light-emitting device 121a and the second light-emitting device 121b may be collectively referred to as the light-emitting devices 121. The first red light-emitting device 124a and the second red light-emitting device 124b may be collectively referred to as the red light-emitting devices 124. The first green light-emitting device 125a and the second green light-emitting device 125b may be collectively referred to as the green light-emitting devices 125. The first blue light-emitting device 126a and the second blue light-emitting device 126b may be collectively referred to as the blue light-emitting devices 126. The first line sensor 122a and the second line sensor 122b may be collectively referred to as the line sensors 122.

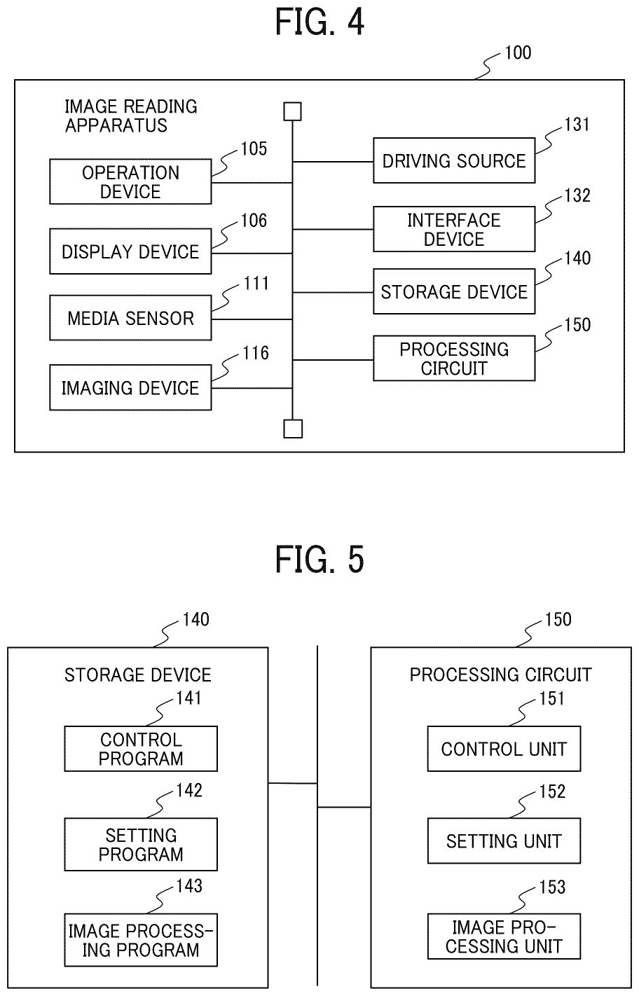

FIG. 4 is a schematic block diagram illustrating a configuration of the image reading apparatus according to the present embodiment.

The image reading apparatus 100 further includes a driving source 131, an interface device 132, a storage device 140, and a processing circuit 150 in addition to the above-described components.

The driving source 131 includes one or multiple motors. The driving source 131 rotates the feed roller 112, the separation roller 113, the first conveyance roller 114, the second conveyance roller 115, the third conveyance roller 117, and/or the fourth conveyance roller 118 in response to a control signal from the processing circuit 150 to convey the medium. One of the first conveyance roller 114 and the second conveyance roller 115 may be a driven roller that rotates following the other roller. One of the third conveyance roller 117 and the fourth conveyance roller 118 may be a driven roller that rotates following the other roller.

The interface device 132 includes an interface circuit compatible with a serial bus such as a universal serial bus (USB). The interface device 132 is electrically connected to an information processing apparatus (e.g., a personal computer or a mobile information processing terminal) to transmit and receive a read image and various kinds of information to and from the information processing apparatus. A communication unit that includes an antenna to transmit and receive wireless signals and a wireless communication interface device to transmit and receive signals through a wireless communication line according to a predetermined communication protocol may be used instead of the interface device 132. The predetermined communication protocol is, for example, a wireless local area network (LAN) communication protocol.

The storage device 140 includes memories such as a random-access memory (RAM) and a read-only memory (ROM), a fixed disk device such as a hard disk, a portable memory such as a flexible disk or an optical disk, etc. The storage device 140 stores computer programs, databases, tables, etc. used for various processes performed by the image reading apparatus 100. The computer programs may be installed in the storage device 140 from a computer-readable portable recording medium using, for example, a known setup program. The portable recording medium is, for example, a compact disc read-only memory (CD-ROM) or a digital versatile disc read-only memory (DVD-ROM). The computer programs may be distributed from, for example, a server and installed in the storage device 140. Further, data such as a setting table is stored in the storage device 140. Details of the setting table are described later.

The processing circuit 150 operates according to a program prestored in the storage device 140. The processing circuit 150 is, for example, a central processing unit (CPU). Alternatively, a digital signal processor (DSP), a large-scale integration (LSI), an application-specific integrated circuit (ASIC), or a field-programmable gate array (FPGA) may be used as the processing circuit 150.

The processing circuit 150 is connected to the operation device 105, the display device 106, the media sensor 111, the imaging device 116, the driving source 131, the interface device 132, the storage device 140, etc. and controls these devices. The processing circuit 150 controls, for example, the driving of the driving source 131 and the imaging of the imaging device 116 to acquire an input image, and transmits the input image to the information processing apparatus via the interface device 132.

FIG. 5 is a schematic diagram illustrating a configuration of the storage device and the processing circuit according to one embodiment.

As illustrated in FIG. 5, the storage device 140 stores a control program 141, a setting program 142, and an image processing program 143. These programs are functional modules implemented by software that operates on the processor. The processing circuit 150 reads the programs from the storage device 140 and operates according to the read programs, thereby functioning as a control unit 151, a setting unit 152, and an image processing unit 153.

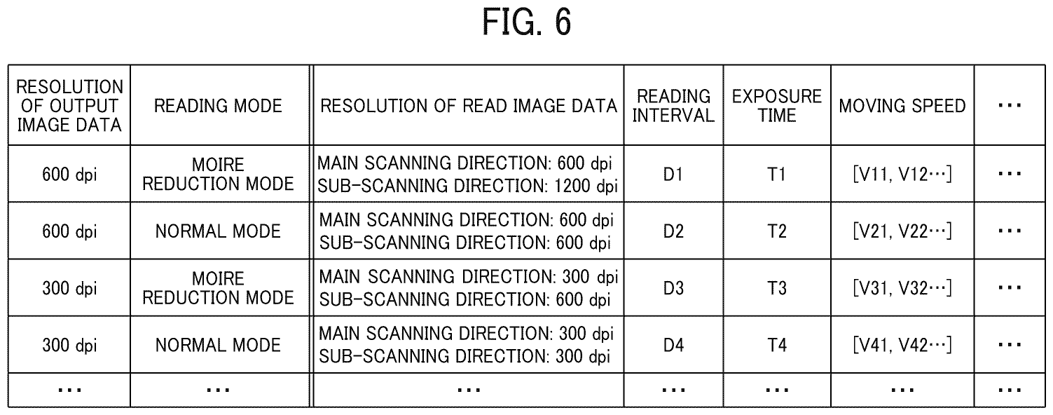

FIG. 6 is a table presenting an example of a data structure of the setting table.

The setting table defines operation settings of the light-emitting devices 121, the line sensors 122, the driving source 131, etc. when the imaging device 116 reads a medium and generates read image data. As illustrated in FIG. 6, the resolution of the read image data, the reading intervals, the exposure time, the moving speed, etc. in association with each other are prestored in the setting table for each combination of the resolution of output image data and the reading mode.

The output image data is an example of image data output by the image processing unit 153 described later. The output image data is image data output from the image reading apparatus 100. The reading modes are operation modes of the image reading apparatus 100 for generating output image data of each resolution. The reading modes include a normal mode and a moire reduction mode. The normal mode is an example of a second mode, and the moire reduction mode is an example of a first mode. In the normal mode, the line sensors 122 read the medium at the same resolution as the resolution of the output image data. The moire reduction mode is a mode for reducing the occurrence of moire in the output image data. In the moire reduction mode, the line sensors 122 read the medium at a resolution higher than the resolution of the output image data. In the moire reduction mode, the line sensors 122 read the medium at a higher resolution than the resolution of the output image data in the sub-scanning direction (media conveyance direction A1) and at the same resolution as the resolution of the output image data in the main scanning direction (width direction A2). In the moire reduction mode, the line sensors 122 may read the medium at a resolution higher than the resolution of the output image data also in the main scanning direction. The reading mode may be set individually for each resolution not set commonly for all the resolutions. For example, the reading mode may be fixedly set to the normal mode when the resolution of the output image data is 600 dots per inch (dpi), and the reading mode may be fixedly set to the moire reduction mode when the resolution of the output image data is 300 dpi.

The read image data is image data generated by reading the medium with the line sensor 122. The reading interval is an interval in the sub-scanning direction between lines read by the line sensor 122 on the medium. The exposure time is an exposure time per line on the medium, that is, the time during which the light-emitting device 121 emits light to one line on the medium. The moving speed is the moving speed of the medium relative to the imaging device 116. In the present embodiment, the moving speed is the speed at which the medium is conveyed by the conveyor. For example, the peripheral speed of each of the feed roller 112, the separation roller 113, the first conveyance roller 114, the second conveyance roller 115, the third conveyance roller 117, and the fourth conveyance roller 118 is set as the moving speed. Instead of the moving speed, an operation parameter (e.g., the rotation speed or the driving interval) of each motor included in the driving source 131 for rotating the corresponding roller may be set.

The settings of the resolution of the read image data, the reading interval, the exposure time, and the moving speed will be described below.

In the normal mode, the resolution of the read image data is set to the same resolution as the resolution of the output image data. On the other hand, in the moire reduction mode, the resolution of the read image data is set to a resolution higher than the resolution of the output image data. In the moire reduction mode, the resolution of the read image data is set to a resolution higher than the resolution of the output image data in the sub-scanning direction and is set to the same resolution as the resolution of the output image data in the main scanning direction. The resolution of the read image data in the moire reduction mode may be set to a resolution higher than the resolution of the output image data also in the main scanning direction.

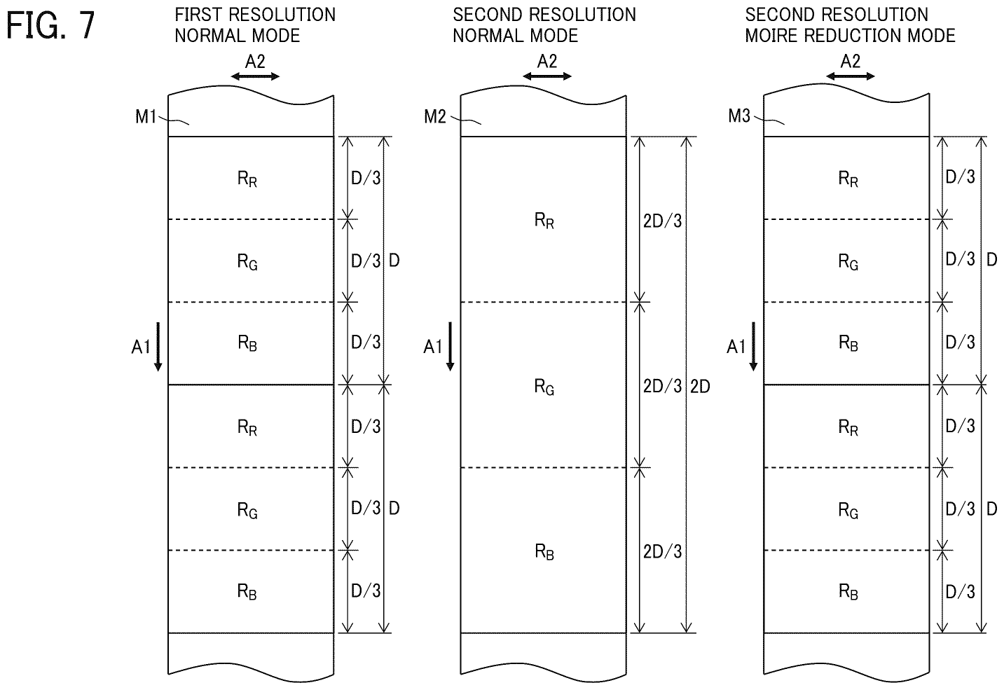

FIG. 7 is a schematic diagram illustrating the color of light emitted by the light-emitting device on a medium being conveyed according to one embodiment.

In FIG. 7, the vertical direction corresponds to the sub-scanning direction (media conveyance direction A1), and the horizontal direction corresponds to the main scanning direction (width direction A2). A medium M1 is a medium from which output image data having a first resolution is generated in the normal mode. A medium M2 is a medium from which output image data having a second resolution is generated in the normal mode. A medium M3 is a medium from which output image data having the second resolution is generated in the moire reduction mode. The second resolution is lower than the first resolution. FIG. 7 illustrates an example in which the second resolution is ½ of the first resolution.

For example, the first resolution is 600 dpi, and the second resolution is 300 dpi.

The color of light emitted by the light-emitting device 121 is switched as each medium moves. Thus, the color of light emitted by the light-emitting device 121 is switched for each position on the medium in the sub-scanning direction.

In the example illustrated in FIG. 7, the reading interval in the sub-scanning direction (i.e., the length of one line in the sub-scanning direction) when the medium is read at the first resolution (i.e., the resolution of the read image data is the first resolution) is a first interval D. In this case, for generating the output image data of the medium M1 at the first resolution in the normal mode, the color (red, green, or blue) of light emitted from the light-emitting device 121 is switched every time the medium moves by a distance D/3, which is ⅓ of the first interval D, in the sub-scanning direction. As a result, each of regions R_{R}, R_{G}, and R_{G} irradiated with red, green, and blue light, respectively, on the medium M1 has a length of D/3 in the sub-scanning direction.

By contrast, the reading interval in the sub-scanning direction when the medium is read at the second resolution which is ½ of the first resolution (i.e., the resolution of the read image data is the second resolution) is a second interval 2D, which is twice the first interval D. For generating the output image data of the medium M2 at the second resolution in the normal mode, the color of the light emitted by the light-emitting device 121 is switched every time the medium M2 moves by a distance 2D/3, which is ⅓ of the second interval 2D, in the sub-scanning direction. As a result, each of the regions R_{R}, R_{G}, and R_{G} irradiated with red, green, and blue light, respectively, on the medium M2 has a length of 2D/3 in the sub-scanning direction.

In the example illustrated in FIG. 7, the resolution for reading the medium in the sub-scanning direction in the moire reduction mode (i.e., the resolution of the read image data) is twice the resolution for reading the medium in the normal mode. In this case, for generating the output image data of the second resolution in the moire reduction mode, the medium needs to be read at the first resolution which is twice the second resolution in the sub-scanning direction. Thus, the reading interval is the first interval D. Accordingly, for generating the output image data of the medium M3 at the second resolution in the moire reduction mode, the color of the light emitted by the light-emitting device 121 is switched every time the medium M3 moves by a distance D/3, which is ⅓ of the first interval D, in the sub-scanning direction. As a result, each of the regions R_{R}, R_{G}, and R_{G} irradiated with red, green, and blue light, respectively, on the medium M3 has a length of D/3 in the sub-scanning direction.

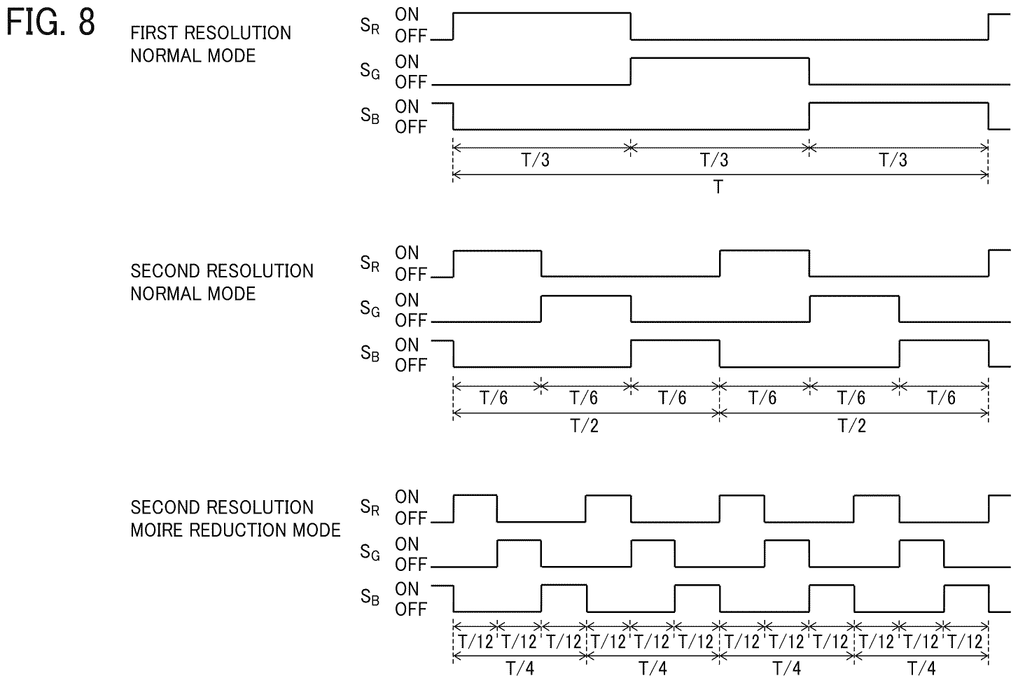

FIG. 8 is a schematic chart illustrating a control signal that defines the timing of irradiation of light of each color by the light-emitting device according to one embodiment. In FIG. 8, the lateral axis represents time, and the vertical axis represents a signal value (ON/OFF). A signal SR is a control signal input to the red light-emitting device 124, the signal S_{G} is a control signal input to the green light-emitting device 125, and the signal S_{B} is a control signal input to the blue light-emitting device 126. The light-emitting device 121 emits light of the color corresponding to the control signal at a timing when its signal value is “ON.”

In the example illustrated in FIG. 8, the exposure time for achieving sufficient light amounts of red, green, and blue to read one line on a medium at the first resolution in the sub-scanning direction in the normal mode is a first exposure time T. In this case, the color (red, green, or blue) of light emitted by the light-emitting device 121 is switched every ⅓ of the first exposure time T (T/3).

By contrast, when the medium is read at the second resolution, ½ of the first resolution suffices for the resolution in the main scanning direction. Accordingly, the image reading apparatus 100 can generate an electric signal for one pixel at the second resolution by combining electric signals output from the imaging elements for two pixels at the first resolution in the main scanning direction. The value obtained by multiplying the sensor area by the exposure time is the total light amount obtained in each pixel. Accordingly, the image reading apparatus 100 can achieve the amount of light necessary for imaging one pixel in the main scanning direction in half the normal exposure time by obtaining an electrical signal for one pixel using the imaging elements for two pixels. Accordingly, the exposure time for achieving the sufficient light amounts of red, green, and blue to read one line on a medium at the second resolution in the sub-scanning direction in the normal mode is a second exposure time T/2, which is ½ of the first exposure time. In this case, the color (red, green, or blue) of light emitted by the light-emitting device 121 is switched every ⅓ of the second exposure time T/2 (T/6).

In the example illustrated in FIG. 8, the resolution for reading the medium in the moire reduction mode is twice the resolution for reading the medium in the normal mode in the sub-scanning direction, and is the same as the resolution for reading the medium in the normal mode in the main scanning direction. In consideration of the working efficiency of the user, the time for reading the entire medium at the second resolution in the moire reduction mode is desirably the same as the time for reading the entire medium at the second resolution in the normal mode. Accordingly, the exposure time per line when the output image data of the second resolution is generated in the moire reduction mode, that is, when the medium is read at the first resolution in the sub-scanning direction in the moire reduction mode, is a third exposure time T/4, which is ½ of the second exposure time T/2. In this case, the color (red, green, or blue) of light emitted by the light-emitting device 121 is switched every ⅓ of the third exposure time T/4 (T/12).

When generating the output image data at the second resolution in the moire reduction mode, the image reading apparatus 100 can use the image sensor for two pixels having the first resolution in the main scanning direction for imaging one pixel at the second resolution similar to the normal mode. However, the number of lines per inch read for generating the output image data at the second resolution in the moire reduction mode is twice the number of lines per inch read for generating the output image data at the second resolution in the normal mode. Accordingly, an exposure time sufficient for the line sensor 122 to read each line is not secured. Accordingly, the image reading apparatus 100 corrects the image in a process described later to make the brightness value of each pixel of the image substantially the same as the brightness value obtained with a sufficient exposure time. Note that also when the line sensor 122 reads the medium at the first resolution in the main scanning direction in the moire reduction mode, the exposure time per line may be the third exposure time T/4. In this case, since the image reading device 100 cannot use image sensors used to image two pixels in the first resolution to generate one pixel in the second resolution, the image reading apparatus 100 corrects the image in the process described later to make the brightness value of each pixel of the image substantially the same as the brightness value obtained with a sufficient exposure time.

In the examples illustrated in FIGS. 7 and 8, in a first setting in which the resolution of the output image data is set to the first resolution and the reading mode is set to the normal mode, the resolution of the read image data is set to the first resolution. In the first setting, the reading interval is set to the first interval D, the exposure time per line is set to the first exposure time T, and the moving speed is set to a first moving speed D/T obtained by dividing the first interval D by the first exposure time T.

Further, in a second setting in which the resolution of the output image data is set to the second resolution and the reading mode is set to the normal mode, the resolution of the read image data is set to the second resolution. In the second setting, the reading interval is set to the second interval 2D, the exposure time per line is set to the second exposure time T/2, and the moving speed is set to a second moving speed 4D/T obtained by dividing the second interval 2D by the second exposure time T/2. In other words, the reading interval in the second setting is twice the reading interval in the first setting. The exposure time in the second setting is ½ of the exposure time in the first setting. The moving speed in the second setting is four times the moving speed in the first setting.

Further, in a third setting in which the resolution of the output image data is set to the second resolution and the reading mode is set to the moire reduction mode, the resolution of the read image data in the sub-scanning direction is set to the first resolution and the resolution of the read image data in the main scanning direction is set to the second resolution. In the third setting, the reading interval is set to the first interval D, the exposure time is set to the third exposure time T/4, and the moving speed is set to the second moving speed 4D/T obtained by dividing the first interval D by the third exposure time T/4. In other words, the reading interval in the third setting is the same as the reading interval in the first setting and is ½ of the reading interval in the second setting. The exposure time in the third setting is ¼ of the exposure time in the first setting and ½ of the exposure time in the second setting. The moving speed in the third setting is four times the moving speed in the first setting and is the same as the moving speed in the second setting.

The settings illustrated in FIGS. 7 and 8 are merely examples, and the first resolution and the second resolution may be set as desired as long as the second resolution is higher than the first resolution. In any case, when the reading mode is the same, the reading interval when the resolution of the output image data is low is set to a value larger than the reading interval when the resolution of the output image data is high. When the reading mode is the same, the exposure time per line when the resolution of the output image data is low is shorter than the exposure time per line when the resolution of the output image data is high. When the reading mode is the same, the moving speed when the resolution of the output image data is low is higher than the moving speed when the resolution of the output image data is high.

Further, when the resolution of the output image data is the same, the reading interval in the moire reduction mode is smaller than the reading interval in the normal mode. When the resolution of the output image data is the same, the exposure time per line in the moire reduction mode is shorter than the exposure time per line in the normal mode. When the resolution of the output image data is the same, the moving speed in the moire reduction mode may be the same as the moving speed in the normal mode.

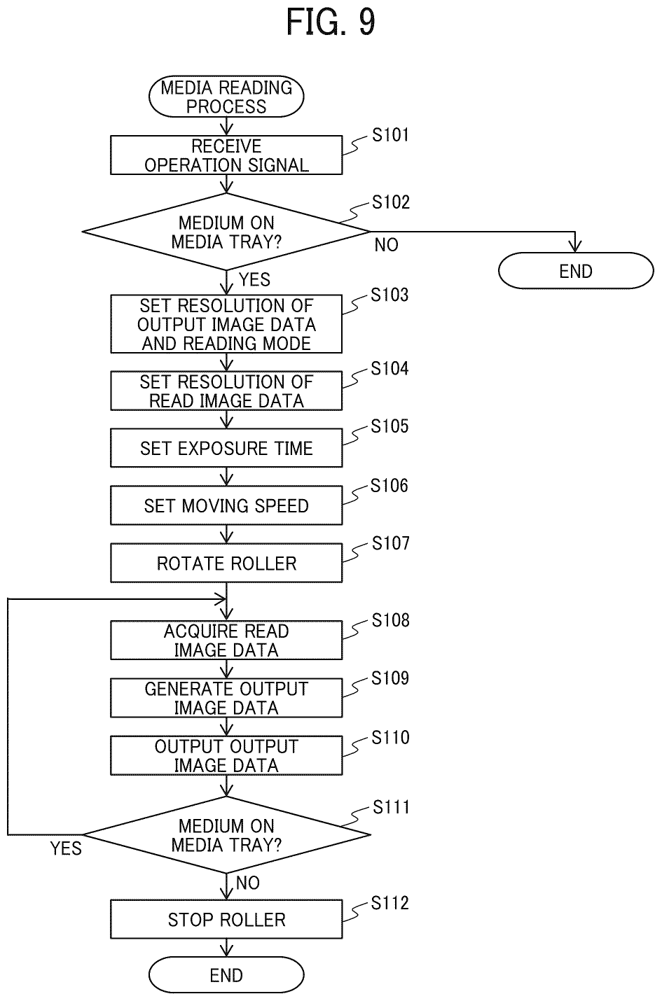

FIG. 9 is a flowchart of example operations in a media reading process.

A description is given below of example operations in the media reading process performed by the image reading apparatus 100 with reference to the flowchart in FIG. 9. The operation process described below is executed, for example, by the processing circuit 150 in cooperation with the components of the image reading apparatus 100 according to the program prestored in the storage device 140.

In step S101, the control unit 151 stands by until an operation signal instructing the reading of a medium is received from the operation device 105 or the interface device 132. The operation signal is output when a user inputs an instruction to read the medium using the operation device 105 or the information processing device.

The operation signal may include job information designated by the user. The job information indicates settings related to the media reading process. The job information includes settings such as the type of media (e.g., paper sheet, card, business card, or photograph), color settings of output image data (e.g., multicolor, grayscale, or monochrome), resolution (e.g., 200 dpi, 300 dpi, or 600 dpi), reading side (double-sided or single-sided), or reading mode.

In step S102, the control unit 151 acquires a media signal from the media sensor 111 and determines whether a medium is placed on the media tray 103 based on the acquired media signal. When no media are placed on the media tray 103, the control unit 151 ends the series of steps.

By contrast, when a medium is placed on the media tray 103, the setting unit 152 sets the resolution of the output image data and the reading mode (step S103). The setting unit 152 identifies the resolution of the output image data and the reading mode from, for example, the job information included in the operation signal and sets (stores) the identified resolution and reading mode in the storage device 140. The job information may not be included in the operation signal but may be set by the user using the operation device 105 or the information processing apparatus and stored in the storage device 140 before the operation signal is transmitted.

As described above, the setting unit 152 can set the first resolution and the second resolution illustrated in FIGS. 7 and 8 as the resolution of the output image data and can set the normal mode and the moire reduction mode as the reading mode. This allows the user to acquire the output image data of a desired resolution generated in a desired reading mode.

The initial mode of the reading mode may be the moire reduction mode. Then, the image reading apparatus 100 can generate output image data in the moire reduction mode to reduce the occurrence of moire when the reading mode is not set by the user.

In step S104, the setting unit 152 sets the resolution of the read image data. The setting unit 152 refers to the setting table and identifies the resolution of the read image data corresponding to the resolution of the output image data and the reading mode set in step S103. The setting unit 152 sets the identified resolution in the imaging device 116 so that the medium is read at the identified resolution.

In step S105, the setting unit 152 sets the exposure time. The setting unit 152 refers to the setting table and identifies the exposure time corresponding to the resolution of the output image data and the reading mode set in step S103. The setting unit 152 sets the identified exposure time in the imaging device 116 so that the color of light emitted to the medium is switched according to the identified exposure time in reading of the medium.

In step S106, the setting unit 152 sets the moving speed. The setting unit 152 refers to the setting table and identifies the moving speed corresponding to the resolution of the output image data and the reading mode set in step S103. The setting unit 152 sets the rotation speed, the driving interval, or the like corresponding to the identified moving speed in each motor of the driving source 131 so that the medium moves (is conveyed) at the identified moving speed.

In step S107, the control unit 151 drives the driving source 131 to rotate the rollers to feed and convey the medium. This causes the conveyor to convey the medium at the moving speed set in step S106.

When the resolution of the output image data is the first resolution and the reading mode is the normal mode, the control unit 151 causes the medium to move at the first moving speed. By contrast, when the resolution of the output image data is the second resolution and the reading mode is the normal mode, the control unit 151 causes the medium to move at the second moving speed higher than the first moving speed. Further, when the resolution of the output image data is the second resolution and the reading mode is the moire reduction mode, the control unit 151 causes the medium to move at the second moving speed higher than the first moving speed. Thus, the control unit 151 controls the speed of a relative movement between the reading object and the image reader. In this way, the image reading apparatus 100 can reduce the time for reading the medium at the second resolution and increase the work efficiency of the user.

In step S108, the image processing unit 153 causes the imaging device 116 to image the medium and acquire the read image data from the imaging device 116. The imaging device 116 reads the medium at the resolution set in step S104 while irradiating the medium with light of the respective colors according to the exposure time set in step S105. Thus, the imaging device 116 reads the medium at the corresponding reading intervals and generates the read image data at that resolution.

When the resolution of the output image data is the first resolution and the reading mode is the normal mode, the imaging device 116 reads the medium at the first resolution and generates read image data of the first resolution. By contrast, when the resolution of the output image data is the second resolution and the reading mode is the normal mode, the imaging device 116 reads the medium at the second resolution and generates read image data of the second resolution. Further, when the resolution of the output image data is the second resolution and the reading mode is the moire reduction mode, the imaging device 116 reads the medium at the first resolution and generates read image data of the first resolution.

The image reading apparatus 100 can reduce the length of one line to be read in the sub-scanning direction by reading the medium at a resolution higher than the resolution of the output image data in the moire reduction mode. For example, the printed dot size on the medium may be smaller than the second interval 2D illustrated in FIG. 7. In such a case, when the medium is read at the second resolution in the normal mode, each printed dot passes through the imaging position before being irradiated with light of all of red, green, and blue. In this case, color unevenness occurs in both the read image data and the output image data. As the color unevenness periodically occurs in the read image data and the output image data, moire occurs.

By contrast, if the print dot size on the medium is smaller than the second interval 2D but is equal to or larger than the first interval D, each print dot is reliably irradiated with light of all of red, green, and blue when the medium is read at the first resolution in the moire reduction mode. Accordingly, the image reading apparatus 100 can reduce the color unevenness in the output image data by reading the medium at a resolution higher than the resolution of the output image data in the moire reduction mode. As a result, the occurrence of moire in the output image data can be reduced.

To prevent the occurrence of moire, the medium is preferably read at a resolution that is equal to or higher than twice the printing resolution (lines per inch or LPI) of the medium. For example, moire is likely to occur when the medium of about 150 LPI is read at the reading resolution of 300 dpi. Similarly, moire is likely to occur when the medium of about 300 LPI is read at the reading resolution of 600 dpi. However, the print resolution (lines per inch) of a medium is typically 200 LPI or less. Accordingly, when the resolution of the output image data is 300 dpi, the image reading apparatus 100 is highly likely to prevent the occurrence of moire in the output image data by reading the medium at the resolution of 600 dpi in the moire reduction mode. In other words, when the first resolution is 600 dpi, the image reading apparatus 100 is highly likely to prevent the occurrence of moire in the output image data.

When the resolution of the output image data is the first resolution and the reading mode is the normal mode, the imaging device 116 reads the medium at the first interval in the sub-scanning direction. By contrast, when the resolution of the output image data is the second resolution and the reading mode is the normal mode, the imaging device 116 reads the medium at the second interval greater than the first interval in the sub-scanning direction. Further, when the resolution of the output image data is the second resolution and the reading mode is the moire reduction mode, the imaging device 116 reads the medium at the first interval in the sub-scanning direction. In other words, the image reading apparatus 100 sets the reading interval for reading a medium at the second resolution in the moire reduction mode to be the same as the reading interval for reading the medium at the first resolution in the normal mode. The image reading apparatus 100 can reduce the occurrence of moire in the output image data by reducing the length in the sub-scanning direction of one line read in the moire reduction mode.

When the resolution of the output image data is the first resolution and the reading mode is the normal mode, the exposure time per line is set to the first exposure time. By contrast, when the resolution of the output image data is the second resolution and the reading mode is the normal mode, the exposure time per line is set to the second exposure time shorter than the first exposure time. Further, when the resolution of the output image data is the second resolution and the reading mode is the moire reduction mode, the exposure time per line is set to the third exposure time shorter than the second exposure time. In other words, the image reading apparatus 100 sets the exposure time for reading a medium at the first resolution in the moire reduction mode to be shorter than the exposure time for reading the medium at the second resolution in the normal mode. Thus, the image reading apparatus 100 can reduce the time for reading the medium in the moire reduction mode and increase the work efficiency of the user.

When the resolution of the output image data is the first resolution and the reading mode is the normal mode, the exposure time per line is set to the first exposure time. In other words, the imaging device 116 reads the medium under a first exposure condition in which the exposure time per line is the first exposure time. By contrast, when the resolution of the output image data is the second resolution and the reading mode is the normal mode, the exposure time per line is set to the second exposure time shorter than the first exposure time. In other words, the imaging device 116 reads the medium under a second exposure condition in which the exposure time per line is the second exposure time. Further, when the resolution of the output image data is the second resolution and the reading mode is the moire reduction mode, the exposure time per line is set to the third exposure time shorter than the second exposure time. In other words, the imaging device 116 reads the medium under a third exposure condition in which the exposure time per line is the third exposure time.

As described above, the image reading apparatus 100 sets the exposure time for reading a medium at the first resolution in the moire reduction mode to be shorter than the exposure time for reading the medium at the second resolution in the normal mode. Thus, the image reading apparatus 100 can reduce the time for reading the medium in the moire reduction mode and increase the work efficiency of the user.

The image reading apparatus 100 sets the exposure time for reading a medium at the first resolution to generate output image data having the second resolution to be shorter than the exposure time for read the medium at the first resolution to generate output image data having the first resolution. Further, the image reading apparatus 100 sets the exposure time for reading a medium at the second resolution to generate output image data having the second resolution to be shorter than the exposure time for read the medium at the first resolution to generate output image data having the first resolution. Thus, the image reading apparatus 100 can reduce the time for reading the medium at the second resolution and increase the work efficiency of the user.

In step S109, the image processing unit 153 generates output image data based on the acquired read image data. When the reading mode is the normal mode, the image processing unit 153 does not correct the read image data and uses the read image data as output image data.

By contrast, when the reading mode is the moire reduction mode, the image processing unit 153 changes the resolution of the acquired read image to the resolution of the output image data set in step S103. As described above, the imaging device 116 reads the medium at a resolution higher than the resolution of the output image data and generates the read image data in the moire reduction mode.

The image processing unit 153 reduces the size of the read image data (thins out pixels in the read image data) by using a known image processing technique such as a nearest neighbor interpolation or linear interpolation, and changes the resolution of the read image data to the resolution of the output image data. The image processing unit 153 corrects the read image data to generate the output image data in which the number of lines per inch is smaller than the number of lines per inch in the read image data. When the line sensor 122 has read the medium at a resolution higher than the resolution of the output image data in the main scanning direction in the moire reduction mode, the image processing unit 153 thins out pixels in the read image data also in the main scanning direction to generate the output image data.

In other words, when the resolution of the output image data is the first resolution and the reading mode is the normal mode, the image processing unit 153 does not correct the read image data and uses the read image data as output image data. Also, when the resolution of the output image data is the second resolution and the reading mode is the normal mode, the image processing unit 153 does not correct the read image data and uses the read image data as output image data. As a result, the image reading apparatus 100 can appropriately generate output image data having a resolution designated by the user. By contrast, when the resolution of the output image data is the second resolution and the reading mode is the moire reduction mode, the image processing unit 153 converts the image data having the first resolution into image data having the second resolution lower than the first resolution. Thus, the image reading apparatus 100 can generate output image data having the second resolution with the occurrence of moire reduced.

When the reading mode is the moire reduction mode, the image processing unit 153 corrects the brightness value of each pixel in the read image data. As described above, when the read image data is generated in the moire reduction mode, the exposure time is not sufficient for the line sensor 122 to read each line. The image processing unit 153 corrects the brightness value of each pixel in the read image data to be substantially the same as the brightness value achieved when the exposure time is sufficient using a known image processing technique such as multiply-accumulate operation in which the brightness value of each pixel is multiplied by a predetermined coefficient and/or adding a predetermined offset, or gamma correction. For example, the image processing unit 153 corrects the brightness value of each pixel to make the maximum value and the minimum value of the brightness value of the pixels substantially the same between when the exposure time is sufficient and when the exposure time is not sufficient. The image processing unit 153 corrects the read image data to generate the output image data in which the brightness value of each pixel is higher than the brightness value of each pixel in the read image data.

In other words, when the resolution of the output image data is the second resolution and the reading mode is the moire reduction mode, the image processing unit 153 further corrects the brightness of the read image data. Thus, the image reading apparatus 100 can generate output image data having appropriate brightness while reducing an increase in time for reading a medium in the moire reduction mode.

Further, when the exposure time is shortened, there is the risk of increases in the noise in the read image data. Accordingly, when the reading mode is the moire reduction mode, the image processing unit 153 may apply a known noise removal filter such as a smoothing filter to the read image data to remove noise in the read image data.

In step S110, the image processing unit 153 outputs by transmitting the generated output image data to the information processing apparatus via the interface device 132 or displaying the generated output image data on the display device 106.

In step S111, the control unit 151 determines whether a medium remains on the media tray 103 based on the media signal received from the media sensor 111. When a medium remains on the media tray 103, the control unit 151 returns the process to step S108 and repeats the steps S108 to S111.

When no media remain on the media tray 103, the control unit 151 controls the driving source 131 to stop the rollers in step S112 and ends the series of steps.

As described above in detail, the image reading apparatus 100 reads a medium with a high resolution with a reduced exposure time and converts the generated image data to have a low resolution. Thus, the image reading apparatus 100 can reduce the occurrence of moire in the generated image data while reducing an increase in the time for reading a medium.

The image reading apparatus 100 can reduce the occurrence of moire in the read image data without reducing the resolution or the color reproducibility. Further, since the image reading apparatus 100 can reduce the occurrence of moire in the read image data, execution of filter processing such as a smoothing filter to reduce moire is not necessary. Accordingly, blur of the entire output image data can be prevented. Thus, the image reading apparatus 100 can reduce a decrease in the character recognition rate in the optical character recognition (OCR).

Further, since the CIS is inexpensive but has high resolving power, the CIS may read dots printed on a medium clearly, which may result in the occurrence of moire in read image data. Since the image reading apparatus 100 can reduce the occurrence of moire in the read image data, an inexpensive CIS is usable as the line sensor 122, and the apparatus cost can be reduced.

Further, although the single-line monochrome sensor is inexpensive as compared with the three-line color sensor, there is a high possibility that the positions on the medium irradiated with the light of respective colors deviate, causing moire in the read image data. Since the image reading apparatus 100 can reduce the occurrence of moire in the read image data, an inexpensive single-line monochrome sensor is usable as the line sensor 122, and the apparatus cost can be reduced.

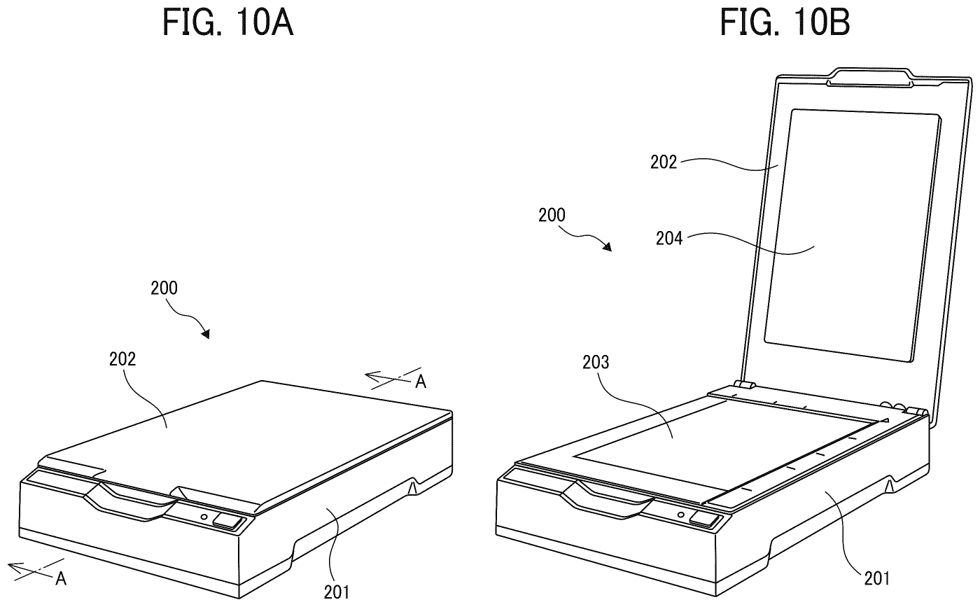

FIGS. 10A and 10B are diagrams each illustrating a configuration of an image reading apparatus according to another embodiment. FIG. 10A is a perspective view of an image reading apparatus 200 in which a cover 202 is closed, and FIG. 10B is a perspective view of the image reading apparatus 200 in which the cover 202 is open.

As illustrated in FIGS. 10A and 10B, the image reading apparatus 200 is, for example, a flatbed scanner. The image reading apparatus 200 includes a housing 201, a cover 202, etc.

The housing 201 includes a glass plate 203. The glass plate 203 is on the upper side of the housing 201 on which a medium is placed. That is, the glass plate 203 forms a medium placement face.

The cover 202 includes a backing member 204, etc. The cover 202 is openable and closable with respect to the housing 201. When the cover 202 is open, a medium can be placed on the glass plate 203 of the housing 201. When the cover 202 is closed, the backing member 204 faces an imaging device located below the glass plate 203 (in the housing 201). The side of the backing member 204 facing the imaging device has a white color similarly to the first backing member 123a, and the image reading apparatus 200 corrects, for example, the shading of an image based on an image signal obtained by imaging the backing member 204.

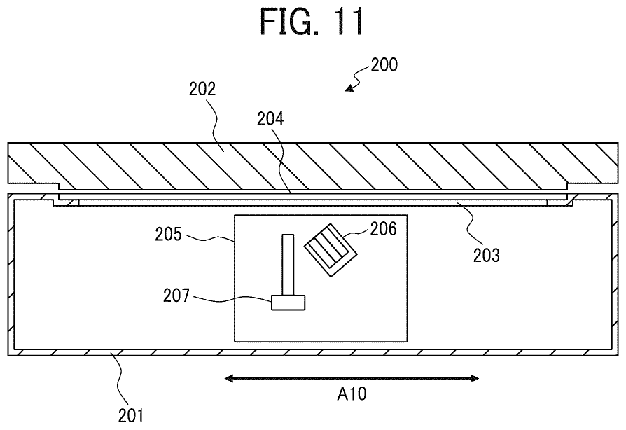

FIG. 11 is a cross-sectional view of the image reading apparatus 200. FIG. 11 is a cross-sectional view of the image reading apparatus 200 with the cover 202 closed, taken along line A-A in FIG. 10A.

As illustrated in FIG. 11, the housing 201 contains an imaging device 205. The imaging device 205 is at a position facing the backing member 204 on the cover 202 in the closed state with the glass plate 203 interposed therebetween. The imaging device 205 extends to image a range from one end to the other end of the glass plate 203 in the direction (main scanning direction) parallel to the glass plate 203 and perpendicular to the direction indicated by arrow A10. The imaging device 205 is movable to image a range from one end to the other end of the glass plate 203 in the direction indicated by arrow A10 (sub-scanning direction).

The imaging device 205 is an example of an image reader and reads a medium on the glass plate 203 to generate read image data. The imaging device 205 includes a light-emitting device 206, a line sensor 207, etc.

The light-emitting device 206 is similar in structure to the first light-emitting device 121a. The light-emitting device 206 irradiates the medium placed on the glass plate 203 with red, green, and blue light. The line sensor 207 is similar in structure to the first line sensor 122a. The imaging device 205 further includes a lens that forms an image on the imaging elements and an A/D converter that amplifies the electrical signals output from the imaging elements and performs A/D conversion. The line sensor 207 reads the medium placed on the glass plate 203 line by line and generates read image data.

The image reading apparatus 200 includes the components of the image reading apparatus 100 illustrated in FIG. 4. However, the image reading apparatus 200 includes the imaging device 205 instead of the imaging device 116. In the image reading apparatus 200, the driving source 131 does not rotate rollers to convey a medium but moves the imaging device 205 via a moving mechanism such as a pulley, a belt, a gear, a rack, a pinion, etc.

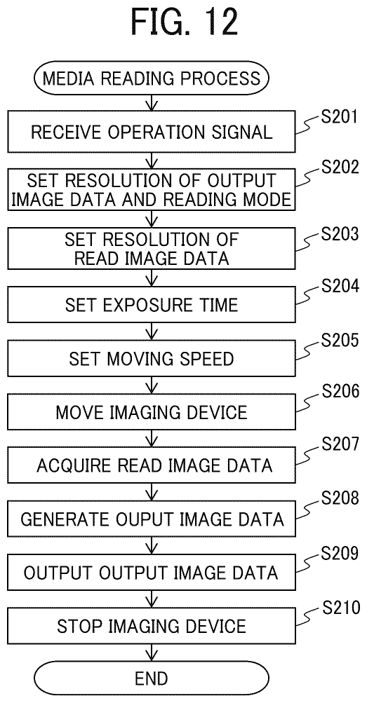

FIG. 12 is a flowchart illustrating example operations in a media reading process according to the present embodiment.

A description is given below of example operations in the media reading process performed by the image reading apparatus 200 with reference to the flowchart of FIG. 12. The operation process described below is executed, for example, by the processing circuit 150 in cooperation with the components of the image reading apparatus 200 according to the program prestored in the storage device 140.

Since the operations in steps S201, S202 to S204, S207 to S209 of FIG. 12 are substantially the same as those in steps S101, S103 to S105, and S108 to S110 of FIG. 9, redundant descriptions are omitted. In the following, the operations in only steps S205, S206, and S210 are described.

In step S205, the setting unit 152 sets a moving speed (step S205). The moving speed is a moving speed of the medium relative to the imaging device 205. In the present embodiment, the moving speed of the imaging device 205 is set as the moving speed in the setting table. Instead of the moving speed, an operation parameter (e.g., the rotation speed or the driving interval) of the motor included in the driving source 131 to move the imaging device 205 may be set. The setting unit 152 refers to the setting table and identifies the moving speed corresponding to the resolution of the output image data and the reading mode set in step S202. The setting unit 152 sets the rotation speed, the driving interval, or the like corresponding to the identified moving speed in each motor of the driving source 131 so that the imaging device 205 moves at the identified moving speed.

In step S206, the control unit 151 drives the driving source 131 to move the imaging device 205 (step S206). Thus, the imaging device 205 moves at the moving speed set in step S205.

When the resolution of the output image data is the first resolution and the reading mode is the normal mode, the control unit 151 causes the imaging device 205 to move at the first moving speed. By contrast, when the resolution of the output image data is the second resolution and the reading mode is the normal mode, the control unit 151 causes the imaging device 205 to move at the second moving speed higher than the first moving speed. Further, when the resolution of the output image data is the second resolution and the reading mode is the moire reduction mode, the control unit 151 causes the imaging device 205 to move at the second moving speed higher than the first moving speed. Thus, the image reading apparatus 200 can reduce the time for reading the medium at the second resolution and increase the work efficiency of the user.

In step S210, the control unit 151 controls the driving source 131 to stop the imaging device 205 and ends the series of steps. The control unit 151 may stop the imaging device 205 at the timing when the input image is acquired in step S207.

As described above in detail, the image reading apparatus 200 can reduce the occurrence of moire in the generated image data while reducing an increase in the time for reading a medium also when the medium is read by moving the imaging device 205.

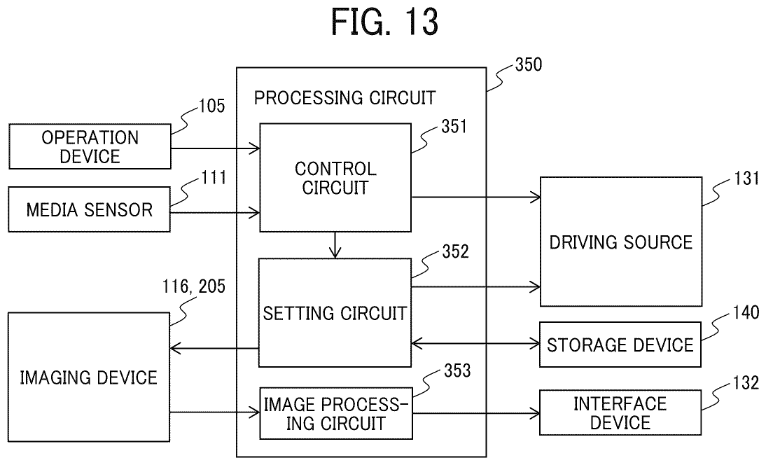

FIG. 13 is a block diagram illustrating a schematic configuration of a processing circuit of an image reading apparatus according to yet another embodiment.

The processing circuit 350 is used in place of the processing circuit 150 of the image reading apparatus 100 or the image reading apparatus 200, and executes, for example, the media reading process instead of the processing circuit 150. The processing circuit 350 includes a control circuit 351, a setting circuit 352, and an image processing circuit 353. These circuits may be implemented by, for example, independent integrated circuits, microprocessors, or firmware, or a combination thereof.

The control circuit 351 is one example of a control unit and functions like the control unit 151. The control circuit 351 receives operation signals from the operation device 105 or the interface device 132 and media signals from the media sensor 111. The control circuit 351 outputs the resolution and the reading mode of the output image data included in the operation signal to the setting circuit 352. The control circuit 351 controls the driving source 131 based on the information received or retrieved.

The setting circuit 352 is one example of the setting unit and functions like the setting unit 152. The setting circuit 352 receives the resolution and the reading mode of the output image data from the control circuit 351 and sets the resolution and the reading mode in the storage device 140. The setting circuit 352 reads the setting table from the storage device 140 and sets the imaging device 116 or 205 and the driving source 131 based on the received or read information.

The image processing circuit 353 is an example of the image processing unit and functions like the image processing unit 153. The image processing circuit 353 acquires the read image data from the imaging device 116, generates output image data based on the read image data, and outputs the output image data to the interface device 132.

As described above, also when the processing circuit 350 is used, the image reading apparatus 100 can reduce the occurrence of moire in the generated image data while reducing an increase in the medium reading time.

Although the preferred embodiments have been described above, the embodiments are not limited thereto. The separation roller 113 may be substituted by a separation pad. Further, the image reading apparatus 100 may have a so-called U-turn path, feed and convey the media placed on the media tray sequentially from the top, and eject the media to the ejection tray.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image reading apparatus comprising:
an image reader including a line sensor to read a reading object line by line, the image reader to read the reading object at a first resolution and generate image data having the first resolution; and
circuitry configured to convert the image data having the first resolution into image data having a second resolution lower than the first resolution and output the image data having the second resolution,
wherein an exposure time per line is shorter when the reading object is read at the first resolution than when the reading object is read at the second resolution.

2. The image reading apparatus according to claim 1,
wherein the circuitry is further configured to set a resolution,
wherein, when the second resolution is set, the image reader generates the image data having the first resolution, and the circuitry converts the image data having the first resolution into the image data having the second resolution.

3. The image reading apparatus according to claim 2, wherein,
when the first resolution is set, the image reader generates the image data having the first resolution, and
the exposure time is shorter when the second resolution is set than when the first resolution is set.

4. The image reading apparatus according to claim 2,
wherein the circuitry is further configured to control a relative movement between the reading object and the image reader,
wherein the circuitry is configured to:
control movement of one of the reading object and the image reader relative to the other one of the reading object and the image reader at a first moving speed when the first resolution is set; and
control movement of one of the reading object and the image reader relative to the other one of the reading object and the image reader at a second moving speed higher than the first moving speed when the second resolution is set.

5. The image reading apparatus according to claim 2,
wherein the circuitry is further configured to control a relative movement between the reading object and the image reader, and
wherein the image reader reads the reading object at a first interval in a sub-scanning direction when the first resolution is set and reads the reading object at the first interval in the sub-scanning direction when the second resolution is set.

6. The image reading apparatus according to claim 2,
wherein the image reading apparatus has a first mode and a second mode different from the first mode as an operation mode,
wherein, when the second resolution is set in the first mode, the image reader generates image data having the first resolution, and the circuitry converts the image data having the first resolution into image data having the second resolution, and wherein, when the second resolution is set in the second mode, the image reader generates image data having the second resolution.

7. The image reading apparatus according to claim 1,
wherein the circuitry is configured to correct brightness in addition to converting the image data having the first resolution into image data having the second resolution.

8. An image reading method comprising:
reading a reading object at a first resolution line by line with an image reader including a line sensor to generate image data having the first resolution;
converting the image data having the first resolution into image data having a second resolution lower than the first resolution; and
outputting the image data having the second resolution,
wherein an exposure time per line is shorter when the reading object is read at the first resolution than when the reading object is read at the second resolution.

9. A non-transitory recording medium storing a plurality of program codes which, when executed by one or more processors, causes the processors to perform a method for controlling a media conveying apparatus, the method comprising:
reading a reading object at a first resolution line by line with an image reader including a line sensor to generate image data having the first resolution;
converting the image data having the first resolution into image data having a second resolution lower than the first resolution; and
outputting the image data having the second resolution,
wherein an exposure time per line is shorter when the reading object is read at the first resolution than when the reading object is read at the second resolution.
